(19) United States
(12) Patent Application Publication
(10) Pub. No.: US 2026/0242138 A1
(43) Pub. Date: Aug. 20, 2026

(54) Modular Storage System and Method for Extracting Elements Stored in Such a System

(71) Applicant: GALAM ROBOTICS, PARIS (FR)

(72) Inventors: Antoine HUE, LEVALLOIS-PERRET (FR); Yohann HENAFF, Paray-Vieille-Poste (FR)

(21) Appl. No.: 19/164,433

(22) PCT Filed: Mar. 22, 2024
(86) PCT No.: PCT/EP2024/057823

§ 371 Date: Sep. 11, 2025

(30) Foreign Application Priority Data
Mar. 24, 2023 (FR) FR2302847

(51) Int. Cl. B65G 1/04; B65G 1/06; B65G 47/82

(52) U.S. Cl. CPC B65G 1/0478; B65G 1/06; B65G 47/82; B65G 2203/0233; B65G 2203/0283; B65G 2207/30

(57) ABSTRACT

The present disclosure relates to a modular storage system comprising: —a modular structure (200); —a rack (300); —an ejection system (400) comprising an ejection module (220a) and an ejector module (230), the ejection module and the ejector module comprising a common side face (410), the ejection module comprising an ejection face (420) opposite the common side face (410) and the ejector module (230) comprising a pusher (430) positioned on the frame (240) of the ejector module (230), the pusher comprising a rod (434), the rod pushing the element to be retrieved placed on the rack located in the ejection module in order to eject the element to be retrieved from the modular structure via the ejection face of the ejection module.

### TECHNICAL FIELD

The present invention relates to automated storage solutions.

It more specifically concerns the extraction of items stored in robotic modular storage structures and proposes to this end a modular storage system and a method for extracting items stored in such a system.

### STATE OF THE ART

With the growth of industrial needs, fine logistics and e-commerce, the development and use of automated solutions for storing and collecting items, such as goods, are proving crucial for many stakeholders. Different types of solutions have been proposed depending on the type of needs they address.

Technologies such as “stacker cranes”, “carousels”, “robotic fleets” or even an implementation of autonomous and mobile robots allow moving stored items from one location to another. These technologies differ in their nature and in their performance, and are therefore not adapted to the same usages. In addition, they do not provide a compact storage solution that can be adapted to any type of space, in particular small ones, and that offers a high distribution rate while limiting the need for manual intervention and thus facilitating its use.

Patent application WO 2020260639, filed in the name of the Applicant, proposes a compact storage and displacement system, adaptable to many types of storage environments and allowing high distribution rates. This system comprises, on the one hand, a modular structure consisting of a plurality of adjacent receiving modules and, on the other hand, lockers storing the items and able to be moved within the modular structure from one module to another. However, there is a need to improve this system such as the management of the extraction, from the system, of the stored items transported by the lockers.

Document US 2019/062058 A1 proposes a storage and displacement system that is different and more complex than the one previously presented, but which comprises a means for ejecting a single item from a locker. However, this system requires the setup of an auxiliary robot external to the modular system to perform the extraction. In addition, the extraction rates of this system are very low due to the overall operation of the storage system and to the complexity caused by the external presence of the robot.

Therefore, there is a need to improve the performance of the existing modular systems.

### GENERAL DISCLOSURE

One aim of the disclosure is to solve at least one of the aforementioned problems.

To this end, according to one aspect of the present disclosure, there is provided a modular storage system comprising:
a modular structure comprising a plurality of adjacent modules, each module of the plurality of modules comprising a parallelepiped-shaped chassis and having four lateral faces, an upper face and a lower face; and
a locker, able to be moved in the modular structure from one module to an adjacent module, the locker being configured to transport stored items, one of the stored items of which is an item to be extracted from the system.

The modular structure further comprises an ejection system, which itself comprises an ejection module and an ejector module, among the plurality of modules, the ejection module and the ejector module comprising a common lateral face, the ejection module comprising an ejection face opposite to the common lateral face, and the ejector module comprising a pusher positioned on the chassis of the ejector module, said pusher comprising a rod configured to move from a stowed position in which the rod is comprised in the ejector module, to an ejection position in which the rod passes perpendicularly through the common lateral face and extends at least partially into the ejection module, the rod pushing the item to be extracted laid on the locker located in the ejection module to eject said item to be extracted from the modular structure, via the ejection face of said ejection module.

Such a system allows quickly and easily extracting the items stored in the lockers of a modular structure. The ejection system is implemented directly into the modular structure without complicating the displacement of the lockers in the structure.

In addition, the ejection, from a locker, of the items to be extracted occurs by a simple axial translational movement of the rod of the pusher, which reduces the number of movements required. The compactness of the system is thus increased.

Advantageously, but optionally, the disclosed method comprises at least one of the following characteristics, taken alone or in any technically feasible combination:
the pusher further comprises a carriage movable in translation relative to the chassis along at least one direction belonging to the plane of the common face of the ejector module, the rod being movable in axial translation on the carriage and the carriage being configured to position the rod in alignment with the item to be extracted and with the ejection face;
the rod of the pusher comprises a shoe fixed on the rod, the shoe being articulated on the rod so as to adapt its orientation to the contact with a surface of the item to be extracted;
the shoe comprises a surface provided for the contact with the item to be extracted, the contact surface comprising a first dimension and a second dimension larger than the first dimension, the pusher comprising a motorization configured to orient the shoe and its contact surface according to the item to be extracted;
the shoe comprises a sensor configured to acquire information on the relative position of the shoe and of the item to be extracted, and transmit it to the central controller which pilots the displacement of the rod;
the system comprises a central controller, configured to synchronously manage the displacements of the locker in the modular structure and of the pusher;
the system comprises an inert or motorized conveying device, the conveying device comprising an inlet and an outlet, the inlet of the conveying device being adjacent to the ejection face of the ejection module and the outlet of the conveying device being adjacent to a recovery point, the conveying device being configured to convey the item to be extracted ejected from the ejection module to the recovery point.

According to another aspect, there is proposed a method for extracting an item to be extracted from a system, the method comprising the following steps:
moving the locker comprising the item to be extracted towards the ejection module, the locker being able to enter the ejection module either by its lateral faces other than the common lateral face and the ejection face, or by its lower face or its upper face, the displacement being monitored to position the item to be extracted in front of the pusher;
moving the rod of the pusher from the stowed position to an ejection position, this displacement pushing the item to be extracted out of the locker.

According to another aspect, there is proposed a method for extracting an item to be extracted from a system, the method comprising the following steps:
moving the locker comprising the item to be extracted in the ejection module, the locker being able to enter the ejection module either by its lateral faces other than the common lateral face and the ejection face, or by its lower face or its upper face, the displacement being monitored to position the item to be extracted in front of the pusher;
moving the carriage of the pusher relative to the chassis of the ejector module so that the item to be extracted and the pusher are positioned face to face, and
moving the rod of the pusher from the stowed position to an ejection position, this displacement pushing the item to be extracted out of the locker.

According to another aspect, there is proposed a computer program product including code data configured to control the implementation by a central controller of the steps of a method for extracting an item to be extracted.

### DESCRIPTION OF THE FIGURES

Other characteristics, aims and advantages will emerge from the following description, which is purely illustrative and non-limiting and which should be read in relation to the appended drawings in which:

FIG. 1 illustrates a perspective view of a modular system, according to one embodiment of the present invention;

FIG. 2 illustrates a perspective view of a modular structure comprising an ejection system, according to one embodiment of the present invention;

FIG. 3 illustrates a perspective view of a pusher of an ejection system, according to one embodiment of the present invention;

FIGS. 4A, 4B and 4C illustrate several views of a shoe of a pusher rod, according to one embodiment of the present invention;

FIGS. 5A and 5B illustrate several orientations of the shoe of the rod of a pusher, according to one embodiment of the present invention;

FIG. 6 illustrates a perspective view of a locker, according to one embodiment of the present invention;

FIG. 7 illustrates a sectional view of a compartment of a locker of an ejection system, according to one embodiment of the present invention;

FIG. 8 illustrates several positions of a locker relative to a sensor of the module, according to one embodiment of the present invention;

FIG. 9 illustrates a perspective view of a modular system comprising a conveying device, according to one embodiment of the present invention;

FIG. 10 illustrates a step of moving the locker and the pusher of a method for extracting an item from a modular system, according to one particular implementation of the present invention;

FIG. 11 illustrates a step of moving a push arm of the pusher of a method for extracting an item from a modular system, according to one particular implementation of the present invention;

FIG. 12 illustrates an ejection step of a method for extracting an item from a modular system, according to one particular implementation of the present invention.

In all the figures, similar items bear identical references.

### DETAILED DESCRIPTION

### General Information on the Modular Storage System

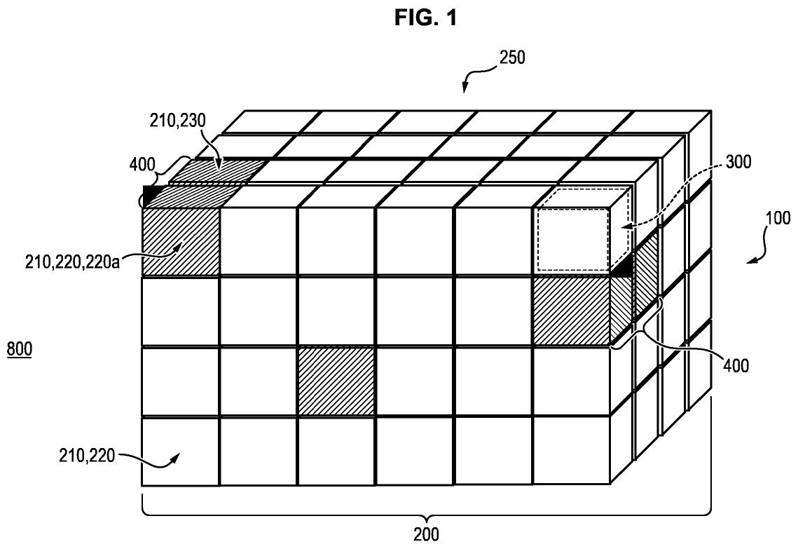

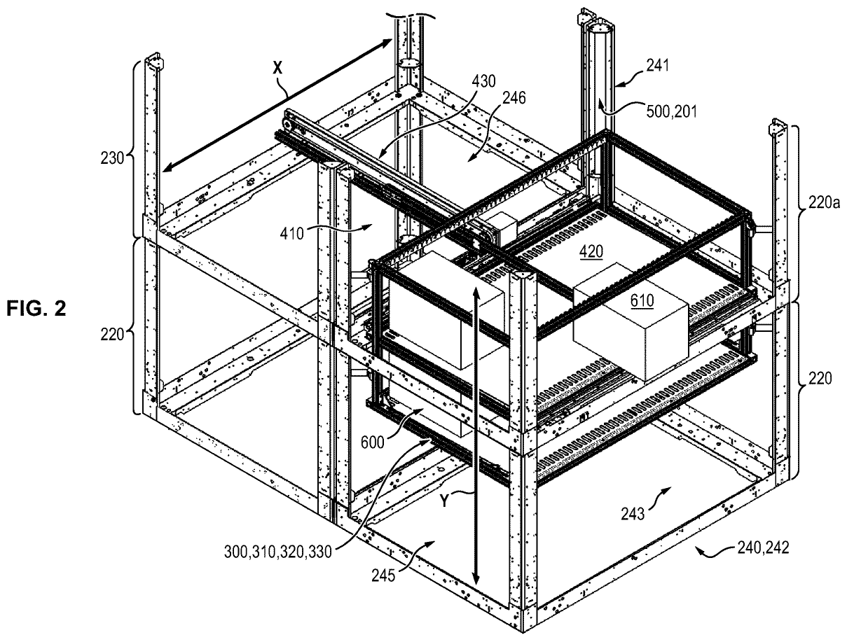

The modular system 100, illustrated in FIG. 1, is a storage system allowing the robotic displacement of stored items 600. The stored items 600, as illustrated in FIG. 2, can be of any type such as parcels, packets, bags, boxes or any other solid material item. This system 100 comprises a modular structure 200, typically laid on the floor of a storage room, and one or more lockers 300 intended to be moved inside said structure 200.

The modular structure 200 is defined by a plurality of adjacent modules 210. The modules 210 are displacement modules 220 or ejector modules 230.

These modules 210, as illustrated in FIG. 2, are juxtaposed, stacked and connected together to form the modular structure 200. The modular structure 200 comprises an outer casing 250 formed by lateral modules 210 of the modular structure 200, modules of which at least one of their faces is not adjacent to another module. For more simplicity, the modular structure 200 will be called hereinafter structure 200. To simplify the understanding, the modular structure 200 represented in FIG. 1 is parallelepipedal in shape, but it could be otherwise, such as forming a non-uniform volume with multiple sides.

The modularity of the structure 200 allows adaptation to any environment; it also facilitates and streamlines the flows of stored items 600 between the point(s) of delivery and the point(s) of withdrawal of the stored items 600.

The modular storage system 100 further includes a plurality of horizontal and vertical actuators 500 and a plurality of control items 201. The horizontal and vertical actuators 500 are configured to drive the lockers 300 in some of the modules 210. Advantageously, a plurality of motors (not represented) allows setting in motion the vertical and horizontal actuators 500. The control items 201 are configured, among other things, to pilot the motors of the actuators 500 and thus manage the displacement in the structure 200 of the locker(s) 300 present in the system 100. According to one embodiment, each module 210 comprises a control item 201 configured to pilot the displacement of a locker 300 present in this same module 210.

The modular storage system 100 may further comprise a central controller 800 configured to generate the orders of controlling the displacement of the different lockers 300 to be transmitted to the control items 201 and thus implement a method for automatically moving the lockers 300.

A control item 201 may include a processing unit (not represented) or computing unit such as a processor, as well as one or more pre-actuators (not represented) able to distribute the energy to the actuators 500 according to the commands received from the central controller 800.

The central controller 800 includes a processing or computing unit, such as a processor, and one or more memories comprising code data generating operating orders configured to implement a method for moving a locker 300 in the system 100 when they are implemented by a processing unit.

Advantageously, the control items 201 are secured to the modules 210 which can be interconnected with each other in their mechanical, electrical and electronic operations.

The mechanical interconnection of the modules 210 allows fixing a module 210 to its adjacent modules 210.

The electrical interconnection of the modules 210 allows propagating the electrical power and thus supplying the various electromechanical systems such as the actuators 500 and the control items 201. This allows supplying the entire system 100 using a limited number of power sources, and in particular limiting the need to load energy storage means, which would be heavy and bulky.

In one preferred embodiment, each module 210 has its own control item 201 which is interconnected to the control items 201 of the adjacent modules 210 via a wired electronic link, forming a global network within the system 100 that allows exchanging and transmitting the commands to any module 210 of the system 100.

This allows limiting the electromagnetic interference and limiting the wiring of the system 100.

### The Modules

The structure 200 is defined by a plurality of vertical uprights 241 and horizontal bars 242 assembled during the installation of said structure 200, which can be easily dismounted or modified.

Said uprights and bars 241, 242 thus define, for each module 210, a chassis 240 of identical shape, which is typically a rectangular parallelepiped and which defines a receiving volume adapted to receive a locker 300.

Advantageously, four uprights 241 extend along a vertical direction Y, the vertical direction Y relating to the arrangement of the system 100 under normal conditions of use. The vertical uprights 241 define four lateral faces 243 of the module. And four horizontal bars 242 extend along two horizontal directions X, the horizontal direction X relating to the arrangement of the system 100 under normal conditions of use. The four horizontal bars define a lower face 245 of the module 210 and an upper face 246 of the module 210 adjacent to the lower face of the module 210 in question. The term “lower” is defined along the vertical direction Y.

The modules 210 are advantageously identical in their structure, so as to limit the production cost of the locker 300 by scale effect and to facilitate the maintenance of the system 100.

Each module 210 comprises information connectors and power connectors (not represented), secured to the chassis 240. This allows limiting the power consumption of the system 100 and limiting the use of batteries and battery-related constraints, in particular those related to recharging.

The information connectors allow the control items 201 of two adjacent modules 210 to transmit information to each other. The power connectors allow transmitting the electrical power from module 210 to module 210.

The central controller 800 is able to detect the connection, the position and the orientation of a new module 210 in the system 100, and is configured to virtually model the modules 210 forming the system 100. The central controller 800 thus updates the virtual model of the system 100 as new modules 210 are connected. The central controller 800 is thus able at any time to know the state of the system 100, its geometry and the distribution of the full and empty modules 210 in the system 100.

The modules 210 of the structure 200 advantageously comprise displacement modules 220 and at least one ejector module 230. Each locker 300 is able to be placed within each displacement module 220.

The displacement modules 220 comprise at least one ejection module 220a whose specific function is explained below.

The displacement modules 220 are configured to allow the lockers 300 to move in the structure 200. The displacement modules 220 are configured to receive a locker 300 or part of a locker 300 in their receiving volume. The lockers 300 can enter the displacement modules 220 indifferently via their lateral faces 243, their lower face 245 or their upper face 246. Such modules allow simplifying the displacements of the lockers 300 in the structure 200 as well as the setup of this same structure 200.

Each displacement module 220 comprises vertical and horizontal actuators 500 secured to the chassis 240. This allows in particular avoiding positioning the actuators 500 on the lockers 300 and thus limiting the weight of the lockers 300 and therefore increasing the weight of the stored items 600, in other words the payload, at equal power. This also allows limiting the power consumption of the system 100 and facilitating the supply of the actuators 500 and limiting the use of batteries and the constraints related to the batteries, in particular those related to recharging.

Advantageously, each displacement module 220 may be equipped with a detection device configured to detect the presence or the absence or the accurate position of a locker 300 within said displacement module 220. It may comprise for example an optical sensor or an inductive proximity detector, or any sensor able to detect the presence of a locker 300 in the displacement module 220.

### Ejection System

The ejector module 230 is a module of the modular structure 200 inside which the lockers 300 cannot move. A structure 200 advantageously comprises one or more ejector modules 230.

The ejector module 230 is adjacent to a lateral face 243 of a lateral displacement module 220 of the structure 200, that is to say the ejector module 230 comprises a lateral face 410 common to a displacement module 220 whose lateral face 243 opposite to the common face 410, called ejection face 420, is not adjacent to any module 210. The displacement module 220, whose lateral face is common to a lateral face of the ejector module 230 and whose opposite lateral face is an ejection face 420, is called ejection module 220a.

The ejector module 230 and the ejection module 220a form an ejection system 400.

The ejector module 230 comprises one or more pushers 430. The pusher 430 has the function of delivering a force to push one or more items to be extracted 610 from the locker 300 placed in the ejection module 220a. Indeed, among the items 600 stored in the lockers 300 of the system 100, some of these items are identified as being to be extracted from the system 100 and are therefore called items to be extracted 610. The setup of a plurality of pushers 430 on the chassis 240 of an ejector module 230 allows simultaneously ejecting several items to be extracted 610 or ejecting the same item to be extracted 610, for example in the case of an item to be extracted 610 of a size or weight requiring a force greater than the force of a single pusher 430.

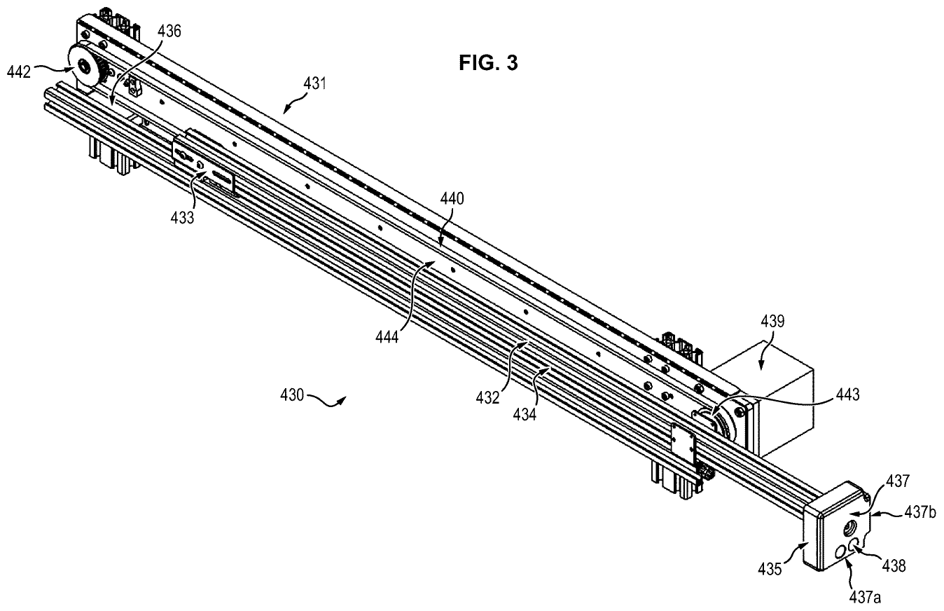

The pusher 430, as illustrated in FIG. 3, comprises a first carriage 431 and a push arm 432. The carriage 431 is attached to the chassis 240 of the ejector module 230 and the push arm 432 is movable in translation relative to the carriage 431.

According to one embodiment, the carriage 431 is fixed on the chassis 240. The pusher 430 is then configured to push the item to be extracted 610 placed in alignment with the pusher 430.

According to another embodiment, the carriage 431 is movably mounted in translation relative to the chassis 240. The carriage 431 is then configured to position the push arm 432 in alignment with the item to be extracted 610.

Advantageously, the carriage 431 can translate in a plane parallel to the common face 410. Moreover, this carriage 431 could in different cases:
Move only along a direction parallel to the common face 410 and included in the plane parallel to the common face 410.
Move only along a direction parallel to the lower face 245 included in the plane parallel to the common face 410.
Along two directions included in the plane parallel to the common face 410. One being parallel to the common face 410, the other being parallel to the lower face 245.

The push arm 432 comprises a second carriage 433, a rod 434 connected to the second carriage 433 and a shoe 435 fixed to one end of the rod 434. The push arm 432 is configured to extend from the ejector module 230 towards the ejection module 220a to eject via the ejection face 420 an item to be extracted 610 laid on the locker 300 located in the ejection module 220a. The push arm 432 extends between two extreme positions 432a, 432b. The push arm 432 comprises a stowed position 432a in which it does not block the movement of the locker 300 in the ejection module 220a, the push arm 432 then being mainly comprised in the ejector module 230 and does not pass through the common face 410, in other words, the push arm 432 is positioned on the side of the ejector module 230 of the common face 410. The push arm 432 also comprises an ejection position 432b in which it has entirely pushed out of the locker 300 the item to be extracted 610 therefrom, the push arm 432 then passes through the common face 431 and extends into the ejection module 220a.

The second carriage 433 slides along the first carriage 431 and along a direction normal to the common face 410. The second carriage 433 thus drives the rod 434 in translation relative to the first carriage 431. The first carriage 431 of the pusher 430 may comprise a guide rail 436 on which the second carriage 433 of the push arm 432 is movably mounted in translation.

Advantageously, the carriage 431 may comprise a second guide item 443 which is placed at the end of the guide rail 436 in order to guarantee the alignment of the push arm 432 with the latter when the push arm 432 is in the ejection position 432b.

The rod 434 can be of several shapes and is fixed by one of its ends to the second carriage 433 of the push arm 432 and by another of its ends to the shoe 435. In order to reduce the overall bulk of the pusher 430 while maintaining its travel, the rod 434 can be a telescopic arm.

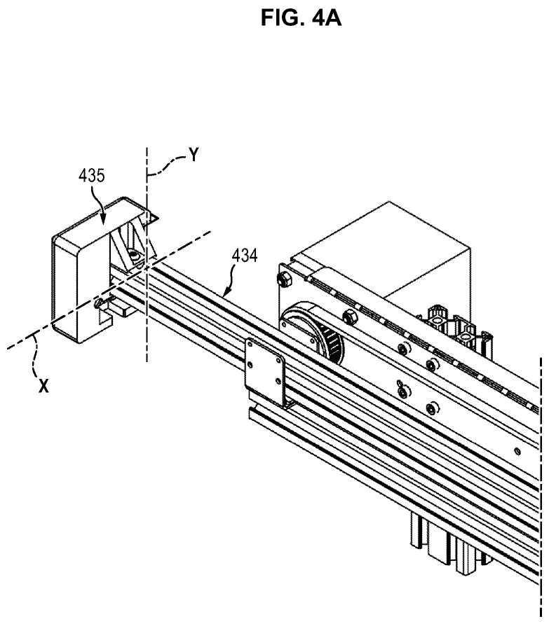

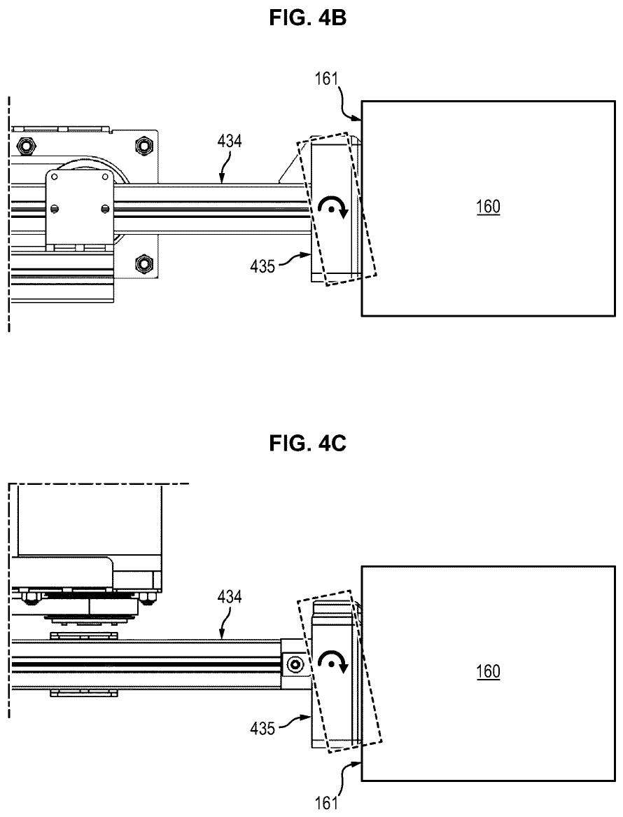

The shoe 435 is fixed to one of the ends of the rod 434, the one closest to the common face 410 in the stowed position 432a and the one closest to the ejection face 420 in the ejection position 432b. The shoe 435 can be fixed to the rod 434 in an articulated manner so as to be able to adapt its orientation to the contact with a surface 611 of the item to be extracted 610. Thus, as illustrated in FIGS. 4A, 4B and 4C, the shoe 435 can be free in rotation about axes perpendicular to the direction of the rod 434.

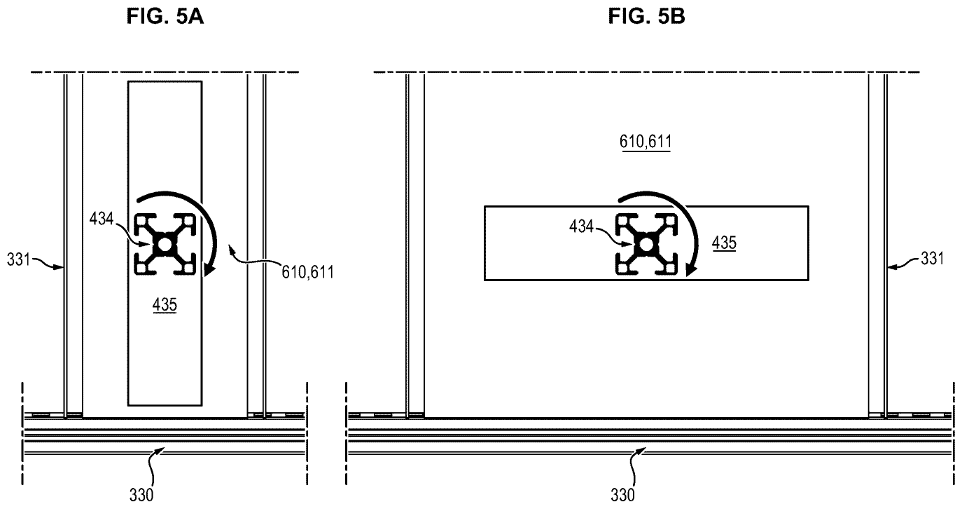

The shoe 435 comprises a contact surface 437 provided for the contact with the item to be extracted 610. The contact surface 437 comprises a first dimension 437a and a second dimension 437b larger than the first dimension 437a. The shoe 435 can thus have a larger dimension along one direction and a smaller dimension along another direction. In addition, and according to one possible embodiment illustrated in FIGS. 5A and 5B, the rod 434 can be driven in rotation so as to be able to orient the shoe 435 fixed to its end. Thus, the shoe 435 is configured to be able to push an item to be extracted 610 from a locker 300 by orienting its contact surface 437 according to the dimensions of the item to be extracted 610, thanks to the rotation of the rod 434. The shoe 435 then aligns the direction of its largest dimension with the largest dimension of the item to be extracted 610 in order to optimize the distribution of the forces on the item to be extracted 610. The pusher 430 can comprise a motorization (not represented) configured to orient the shoe 435 and its contact surface 437 according to the item to be extracted 610.

The shoe 435 preferably comprises a proximity sensor 438. The sensor 438 is thus advantageously placed at the end of the push arm 432 and detects the presence of the item to be extracted 610. This detection allows, on the one hand, temporarily slowing down the speed of the translational movement of the push arm 432 in order to limit the shock at the moment of the contact between the shoe 435 and the item to be extracted 610 and, on the other hand, to validate the presence of the latter. The integration of this sensor 438 within the pusher 430 optimizes its movement since it allows rapid translation of the push arm 432 over a large majority of its movement while limiting jolts during the contact with the item to be extracted 610.

Different technologies can be envisaged for the sensor 438; it can, according to one embodiment, be a proximity sensor of the optical, inductive, capacitive, ultrasonic type, or, according to another embodiment, be a mechanical contact sensor.

The pusher 430 further comprises a device for driving the first carriage 431 along its direction(s) of translation and a device for driving the second carriage 433 of the push arm 432 in its direction of extension.

The pusher 430 may comprise a motor 439, for example an electric motor, which drives the carriage 433 along the rail 436 by means for example of a pulley/belt assembly 440.

Indeed, a drive pulley 441, mounted in rotation relative to the carriage 431, is driven by the motor 439. A second pulley, called free pulley 442, is also mounted in rotation relative to the carriage 431. A belt 444 is placed around these two pulleys in order to advantageously transform the rotational movement of the motor 439 into a translational movement driving the second carriage 433. To do so, the second carriage 433 is therefore connected to the belt 444.

Thus, the ejection system 400 allows simple, rapid and selective extraction of the items to be extracted 610 from the system 100. Indeed, it allows quickly ejecting several items to be extracted 610 present on the same locker or selectively ejecting only some or only one of them.

In addition, the ejection system 400 as previously described is easily implementable in the structure 200 thanks to the ejector 230 and ejection 220a modules, whose chassis 240 is identical to that of the displacement modules 220.

Furthermore, the ejection system 400 allows increasing the extraction rates by its arrangement inside the structure 200. This allows facilitating the displacement of a locker 300 towards and into the ejection system 400.

Finally, the arrangement of the ejection system 400 simplifies the extraction commands and operation by reducing it to a simple two-dimensional positioning of the item to be extracted and of the pusher 430 relative to each other, followed by a unidirectional displacement of the push arm 432 of the pusher 430.

### The Locker

The lockers 300 are positioned in the structure 200. Each of the lockers 300 is configured to store and move stored items 600, some of which are items to be extracted 610.

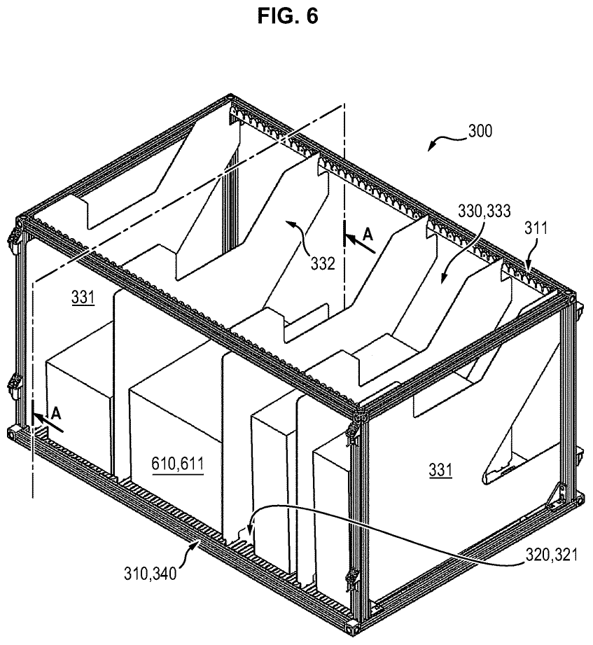

The lockers 300 are of dimensions and shape (in this case, rectangular parallelepiped) allowing them to be received in the displacement modules 220. As illustrated in FIG. 6, they each include for example a chassis 310 and a floor 320 which together form an enclosure 330 adapted to receive and carry an item to be stored 600 and/or an item to be extracted 610.

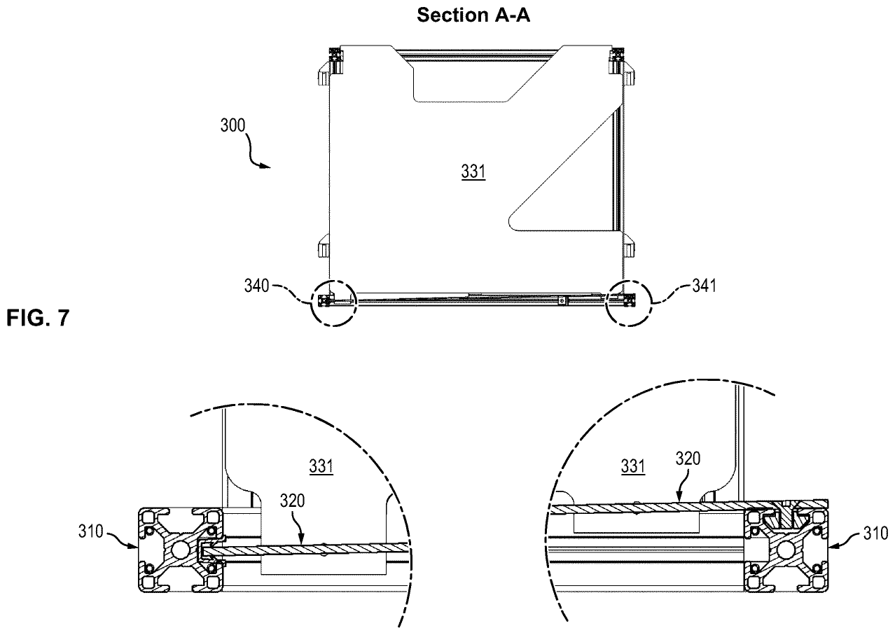

In the embodiment represented, the enclosure has open lateral faces 331, which allows improving accessibility for a user. But in another embodiment, some lateral faces 331 can be closed, as illustrated in FIG. 7.

The enclosure 330 can be divided horizontally and/or vertically by several compartments 332 into several spaces 333. These compartments 332 can be made in various ways. According to one embodiment, it can be a rigid frame in the middle of which a canvas is stretched, or according to another embodiment, a sheet metal. The functions of the compartments 332 are as follows:
facilitating the insertion of the items to be stored 600 into the locker 300.
allowing the position of the items to be stored 600 to be maintained when the locker 300 moves in the modular structure 200.
guiding the item to be extracted 610 when it is pushed out of the locker 300 by the pusher 430.

The number and the position of these compartments 332 may vary from one locker 300 to another in order to adapt to the number and type of the stored items 600. According to one embodiment, the compartments 332 are positioned in the locker 300 at different predetermined positions. These are managed by means of openings 321 present along the floor 320, into which the bottom of the compartments 332 is introduced, as well as by means of notches 311 present along racks fixed on the chassis 310, into which the top of the compartments 332 is introduced. To ensure the verticality of the compartments 332, the openings 321 and the notches 311 must be aligned one above the other.

Non-return mechanisms 340, 341 may be placed at the openings of the locker 300 in order to ensure that the stored items 600 cannot protrude therefrom. It is important to note that at least one of these non-return mechanisms 340, 341 must not obstruct the movements of the stored item 600 during its ejection by the pushers 430 out the locker 300.

As illustrated in FIG. 7, the non-return mechanism 340 may, on one side of the locker 300, be achieved by means of a step between one of the items of the chassis 310 and the floor 320. The non-return mechanism can, on the other side of the locker 300, and still according to the same embodiment, be achieved by via the inclination of the floor 320 (comprised between 1° and 15°) in order to hold in place the stored items 600 in a stable position by the effect of gravity.

According to one embodiment, the locker 300 is positioned using the horizontal actuators 500, partially or completely inside the ejection module 220a, so that the item to be extracted 610 faces the pusher 430 whose carriage 431 remains fixed. And according to another embodiment, the locker 300 is positioned using the vertical actuators 500, partially or completely inside the ejection module 220a, so that the item to be extracted 610 is at the height of the plane on which the pusher 430 translates. The pusher 430 then translates so as to be facing the item to be extracted 610. The vertical Y and horizontal X directions relate to the arrangement of the system 100 under normal conditions of use of the system 100.

In order to be able to manage its position within the ejection module 220a and thus position the item to be extracted 610 in front of a pusher 430 present in the ejector module 230, the locker 300 is put into translation by the actuators 500 present in the ejection module 220a. Advantageously, the locker 300 is equipped with an encoder 350 present on its chassis 310. The locker 300 can be placed in the required position for the ejection of the item to be extracted 610. The information present on the encoder 350 will be interpreted by one or more sensors 360 present in the ejection module 220a.

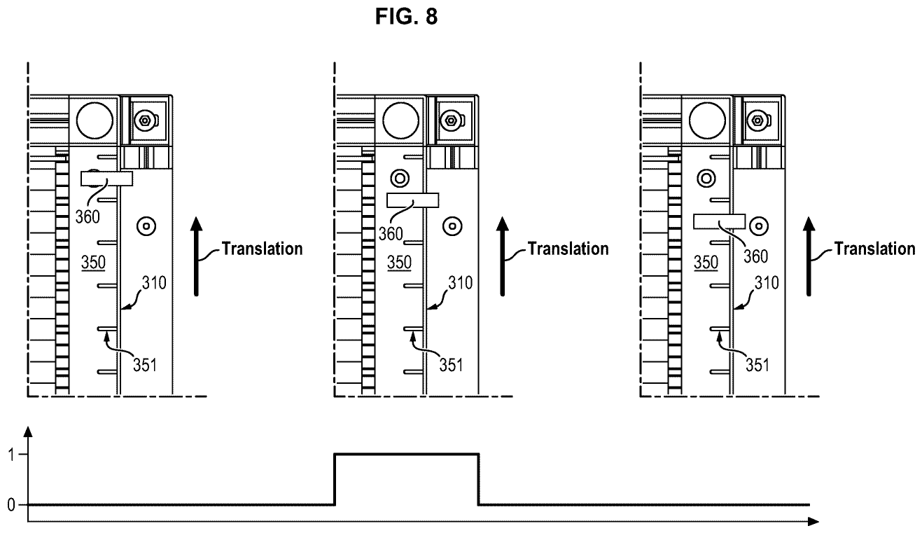

According to one embodiment, and as illustrated in FIG. 8, this encoder 350 may be a cut-out piece having light reflection properties different from those of the chassis 240. The encoder 350 will be fixed to the latter. It will cover part of it while having, at regular intervals, openings that allow seeing the chassis 310. Since the light reflection of these two items is not the same, the sensor 360 determines the openings and thus precisely follows the displacement of the locker 300 in the ejection module 220a, with a precision determined by the size of the interval between two openings of the encoder 350.

The chassis 310 of the locker 300 preferably comprises indentations 312. Some indentations 312 of the locker 300 are configured to cooperate with actuators 500 carried by the horizontal bars 242 of the displacement modules 220 to ensure the displacement along a vertical direction from one displacement module 220 to an adjacent displacement module 220. Some other indentations 312 of the locker 300 may be configured to cooperate with the actuators 500 carried by the vertical uprights of the lockers 300 and ensure a displacement along a vertical direction. The vertical translation devices and the actuators 500 are connected, by wired cabling that runs along the bars, to the central controller 800 (not represented) which manages the displacements of the lockers 300 and actuates these devices accordingly.

### Conveying Device

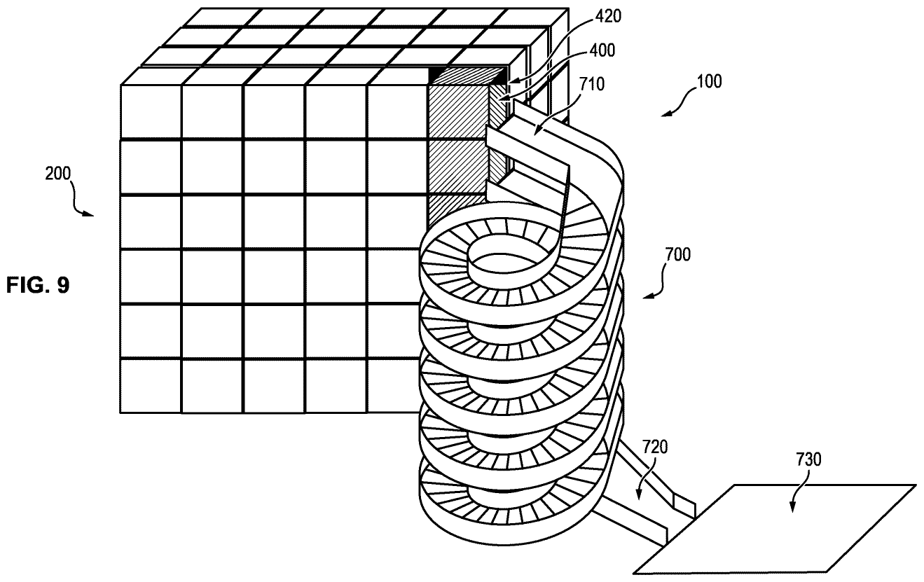

The modular system 100 may further comprise, as illustrated in FIG. 9, an inert or motorized conveying device 700. The conveying device 700 comprises an inlet 710 and an outlet 720. The inlet 710 of the conveying device 700 is adapted to receive an item to be extracted 610 from the system 100 and the outlet 720 of the conveying device 700 is adjacent to a recovery point 730 of the system 100. The conveying device 700 is configured to convey the item to be extracted 610 to the recovery point 730 so that this item to be extracted 610 is extracted from the system 100. The presence of this conveying mechanism 700 is important because it groups the items to be extracted 610 at a single receiving point 730.

The inlet 710 of the conveying device 700 is adjacent to each ejection system 400 and more particularly to the ejection face 420 of each ejection system 400. However, since the ejection systems 400 can be positioned anywhere in the structure 200, it is possible for them to be placed at different heights and away from each other. For this type of application, it can be envisaged to use a roller conveying device 700 mounted on the structure 200. This roller conveying device 700 receives the items to be extracted 610 once ejected from the lockers 300 in which they were, then thanks to judicious inclinations and by the effect of gravity, they are conveyed to the recovery point 730. According to one embodiment, the ejection systems 400 can be positioned one above the other on one of the faces of the structure 200. According to this embodiment, a spiral conveying device 700 having as many inlets as the system 100 comprises ejection systems 400, can be preferred.

### Method for Moving a Locker in the Modular Structure

A locker 300 is advantageously moved in the structure 200 of the system 100 from a first displacement module 220 to a second displacement module 220 such as for example the ejection module 220a following the steps described in document WO 2020/260639 A1 and including the following general steps:
generating commands by the central controller 800;
piloting the motors of the displacement modules 220;
deploying and retracting the actuators 500 of the first displacement module 220 and of the second displacement module 220, so as to translate the locker 300 between these two displacement modules 220 in the case of a vertical displacement of the locker,
or driving the actuators 500 carried by the horizontal bars 242 of the lockers 300 in the case of displacement along a horizontal direction

### Method for Extracting an Item to be Extracted from the Modular System

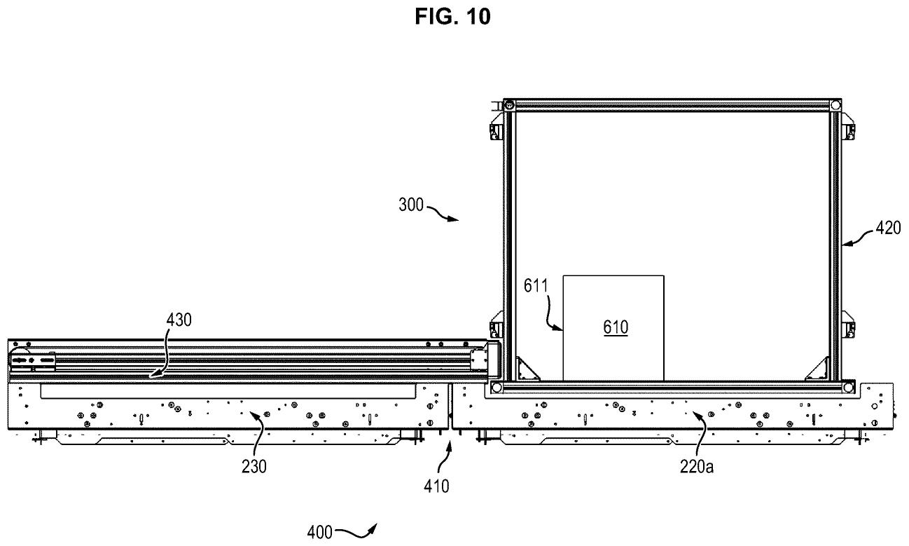

Among items 600 stored in the lockers 300 of the structure 200 of the system 100, one or more items to be extracted 610 may be extracted from the structure 200. An extraction method, illustrated by FIGS. 10 to 12, may first require the implementation of the method for moving a locker 300 in the structure 200.

Once the locker 300 comprising an item to be extracted 610 has been moved in the structure 200 until it is placed in a displacement module 220 adjacent to the ejection module 220a, a positioning step, illustrated in FIG. 10, is implemented. The positioning comprises a displacement E11 of the locker 300 and/or a displacement E12 of the pusher 430. It is interesting to note that the locker 300 can enter the ejection module 220a via its lateral faces 243, other than the common face 410 and the ejection face 420, as well as via its lower face 245 and its upper face 244. In addition, the method follows the same steps in the presence of several items to be extracted 610 from the same locker 300.

Furthermore, in the embodiment according to which the ejector module 230 comprises a plurality of pushers 430, the method follows the same steps. Such a mode of implementation simply improves the speed of ejection and allows ejecting several items to be extracted 610 from the same locker 300 at the same time.

The locker 300 and the pusher 430 are moved (steps E11 and E12) respectively in the ejection module 220a and the ejector module 230 so as to position the item to be extracted 610 and the pusher 430 face to face in the direction of extension of the push arm 432.

According to one mode of implementation, the locker 300 positions the item to be extracted 610 facing the pusher 430 whose translation is then not necessary.

According to another mode of implementation, the locker 300 positions the item to be extracted 610 at the height or at the level, in the horizontal direction, of the pusher 430 and the pusher 430 translates in the ejection module 220a respectively along a horizontal or vertical direction to be positioned facing the item to be extracted 610.

According to another mode of implementation, the locker 300 is positioned entirely in the ejection module 220a then remains stationary and the pusher 430 translates vertically and horizontally relative to the chassis 240 of the ejector module 230 to be positioned facing the item to be extracted 610.

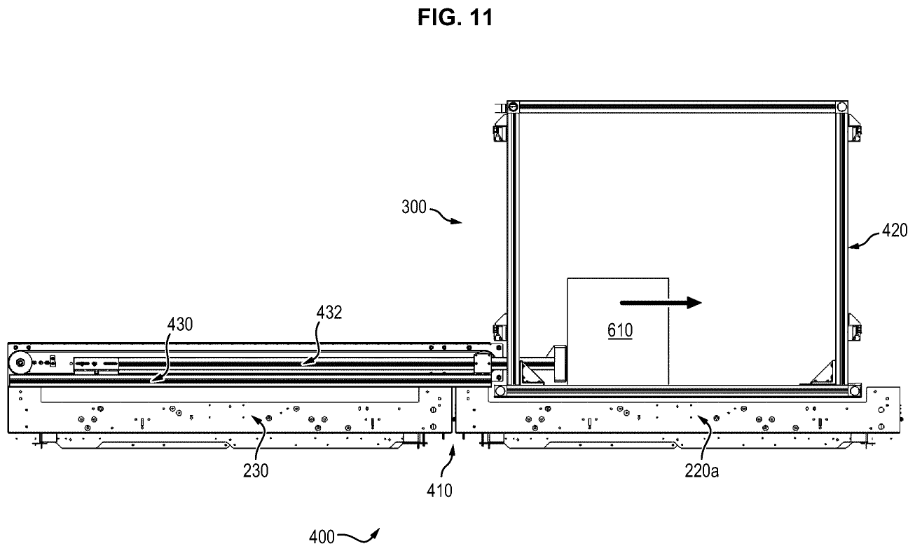

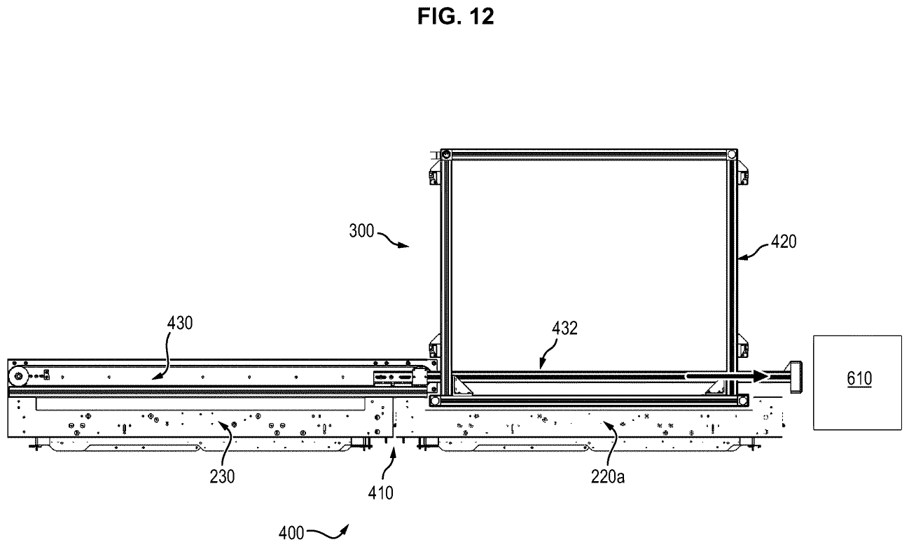

Once the item to be extracted 610 and the pusher 430 are face to face, following the direction of extension of the pushing arm 432 and of the ejection face 420, the pushing arm 432 moves (step E20) as illustrated in FIG. 11. The pushing arm 432 extends from its stowed position 432a to its ejection position 432b under the action of the second carriage 433 of the push arm 432 so that the shoe 435 comes into contact with the item to be extracted 610 and ejects it from the locker 300, as illustrated in FIG. 12. This step, called ejection step, may comprise the following steps:
the push arm 432 initiates a rapid translational movement from the stowed position 432a. This movement will continue until it arrives in the vicinity of the item to be extracted 610;
the sensor 438 of the shoe 435 detects the presence of the item to be extracted 610;
the speed of the push arm 432 then decreases and the push arm 432 extends until the shoe 435 comes into contact with the item to be extracted 610;
once the contact is made, the speed of the push arm 432 increases again until the latter arrives in the ejection position 432b;
the item to be extracted 610 is ejected from the locker 300, as illustrated in FIG. 12, the sensor 438 then detects that it is no longer in contact;
the push arm 432 therefore returns to the stowed position 432a through a rapid translational movement.

1. A modular storage system comprising:
a modular structure comprising a plurality of adjacent modules, each module of the plurality of modules comprising a parallelepiped-shaped chassis and having four lateral faces, an upper face and a lower face;
a locker, able to be moved in the modular structure from one module of the plurality of modules to another module of the plurality of modules adjacent to the module, the locker being configured to transport stored items, one of the stored items of which is an item to be extracted from the system; and
the modular structure comprising an ejection system, the ejection system comprising among the plurality of modules an ejection module and an ejector module,
the ejection module and the ejector module comprising a common lateral face,
the ejection module comprising an ejection face opposite to the common lateral face, and the ejector module comprising a pusher positioned on the chassis of the ejector module,
the pusher comprising a rod configured to move from a stowed position in which the rod is comprised in the ejector module, to an ejection position in which the rod passes perpendicularly through the common lateral face and extends at least partially into the ejection module, and
the rod being configured to push the item to be extracted laid on the locker located in the ejection module to eject the item to be extracted from the modular structure, via the ejection face of the ejection module.

2. The system according to claim 1, wherein the pusher further comprises a carriage movable in translation relative to the chassis along a direction belonging to the plane of the common face of the ejector module, the rod being movable in axial translation on the carriage and the carriage being configured to position the rod in alignment with the item to be extracted and with the ejection face.

3. The system according to claim 1, wherein the rod of the pusher comprises a shoe fixed on the rod, the shoe being articulated on the rod so as to adapt the orientation to the contact with a surface of the item to be extracted.

4. The system according to claim 3, wherein the shoe comprises a surface provided for the contact with the item to be extracted, the contact surface comprising a first dimension and a second dimension larger than the first dimension, the pusher comprising a motorization configured to orient the shoe and the contact surface according to the item to be extracted.

5. The system according to claim 3, wherein the shoe comprises a sensor configured to acquire information on the relative position of the shoe and of the item to be extracted, and transmit it to the central controller which pilots the displacement of the rod.

6. The system according to claim 1, comprising a central controller, configured to synchronously manage the displacements of the locker in the modular structure and of the pusher.

7. The system according to claim 1, comprising an inert or motorized conveying device, the conveying device comprising an inlet and an outlet, the inlet of the conveying device being adjacent to the ejection face of the ejection module and the outlet of the conveying device being adjacent to a recovery point, the conveying device being configured to convey the item to be extracted ejected from the ejection module to the recovery point.

8. A method for extracting an item to be extracted from a system according to claim 1, the method comprising the following steps:
moving the locker comprising the item to be extracted towards the ejection module, the locker being able to enter the ejection module either by the lateral faces other than the common lateral face and the ejection face, or by the lower face or the upper face, the displacement being monitored to position the item to be extracted in front of the pusher;
moving the rod of the pusher from the stowed position to an ejection position, this displacement pushing the item to be extracted out of the locker.

9. The method for extracting an item to be extracted from a system according to claim 1, the method comprising:
moving the locker comprising the item to be extracted in the ejection module, the locker being able to enter the ejection module either by its lateral faces other than the common lateral face and the ejection face, or by the lower face or the upper face, the displacement being monitored to position the item to be extracted in front of the pusher;
moving the carriage of the pusher relative to the chassis of the ejector module so that the item to be extracted and the pusher are positioned face to face, and
moving the rod of the pusher from the stowed position to an ejection position, this displacement pushing the item to be extracted out of the locker.

10. A computer program product including code data configured to control the implementation by a central controller of the method for extracting an item to be extracted according to claim 8 or claim 9.
